(19) United States
(12) Patent Application Publication
(10) Pub. No.: US 2011/0134067 A1
(43) Pub. Date: Jun. 9, 2011

(54) METHOD FOR THE ACQUISITION AND ANALYSIS OF A MULTI-CONTACT TACTILE SENSOR USING A DICHOTOMOUS PRINCIPLE, AND ELECTRONIC CIRCUIT AND MULTI-CONTACT TACTILE SENSOR IMPLEMENTING ONE SUCH METHOD

(75) Inventors: Pascal Joguet, Sadirac (FR); Julien Olivier, Bordeaux (FR)

(73) Assignee: STANTUM, Bordeaux (FR)

(21) Appl. No.: 13/057,627

(22) PCT Filed: Aug. 5, 2009
(86) PCT No.: PCT/FR2009/000979

§ 371 Date: Feb. 4, 2011

(30) Foreign Application Priority Data
Aug. 5, 2008 (FR) 0804468

(51) Int. Cl. G06F 3/041

(52) U.S. Cl. 345/173

(57) ABSTRACT

A method for acquisition and analysis of a multi-contact tactile sensor including a matrix of capture points and an electronic analysis circuit for controlling the acquisition and analysis of the matrix. The method includes acquisition of a sensor detection zone to determine a state of each of contact points of the detection zone and analysis of detection zone to deliver information as a function of an activation state of the contact points. The acquisition and the analysis are repeated iteratively. The acquisition is performed on a detection zone containing the activated contact points determined during a preceding analysis. The detection zone is smaller than the detection zone acquired during the preceding acquisition. The iteration is performed until a pre-determined spatial resolution is obtained. An electronic acquisition and analysis circuit and a multi-contact tactile sensor can implement such a method.

The present invention concerns an acquisition and analysis method for a multicontact touch-sensitive sensor using a dichotomous principle and an electronic circuit and a multicontact touch-sensitive sensor implementing such a method.

### TECHNICAL FIELD

The present invention concerns the field of multicontact touch-sensitive sensors. This type of sensor is provided with means for simultaneous acquisition of the position, pressure, size, shape and movement of a plurality of fingers on its surface in order to control equipment, preferably via a graphical interface. They may be used, although this is not limiting on the invention, as interfaces for personal computers, portable or otherwise, cellular telephones, automatic teller machines (banks, points of sale, ticketing), games consoles, portable multimedia players (digital walkman), control of audiovisual equipment or domestic appliances, control of industrial equipment or GPS navigation systems.

The present invention concerns more particularly an acquisition and analysis method for a multicontact touch-sensitive sensor comprising a matrix of capture points and an acquisition and analysis electronic circuit for controlling acquisition and analysis of the matrix, this method including successively a step of acquisition of a detection area of the sensor to determine the state of each of the contact points of the detection area and a step of analysis of this detection area to deliver information as a function of the state of activation of the contact points.

### PRIOR ART

Already known in the prior art are multicontact touch-sensitive sensors for simultaneously detecting the presence and the state of a plurality of contact points. Such a sensor may be of the matrix type. The voltages at the terminals of each node of the matrix are measured sequentially and quickly in order to create an image of the sensor several times per second.

With a view to the use of these sensors for applications necessitating an imperceptible response time (typing, video games, musical or multimedia application control), it is imperative to be able to measure the activity of a finger with a maximum latency of 20 milliseconds.

One solution proposed in the prior art is described in the patent document FR 2 866 726 covering a device for control by manipulation of virtual graphical objects on a multicontact touch-sensitive screen. This device further comprises an acquisition and analysis electronic circuit for acquiring and analyzing data from the sensor using a sampling frequency of 100 Hz. The sensor may be divided into a plurality of areas in order to effect parallel processing of these areas.

The drawback of this solution lies in the quantity of information generated by measuring all the points of the sensor at a high scanning frequency. The controller scans the whole of the sensor independently of the existence of any contact. Thus the whole of the sensor is scanned even in the absence of any contact. Similarly, even if only one contact area is detected, the whole of the rest of the sensor is scanned. As a general rule, it is desirable to increase the resolution, i.e. to reduce the size of each cell of the sensor. For a given scanning frequency, increasing the resolution increases the quantity of information. The resolution in each contact area is the result of a compromise between on the one hand the spatial resolution of the sensor (the number of cells scanned) and on the other hand the temporal resolution (the time for measuring each cell). In everyday use of this type of sensor, the number of contact points activated is on average very much lower than the total number of contact points of the sensor that can be activated.

### OBJECT OF THE INVENTION

The aim of the present invention is to solve these technical problems by reducing the quantity of acquisitions necessary for determining each of the activated contact points for a given number of contact points.

To this end the invention proposes to carry out a succession of acquisitions and analyses in accordance with a dichotomous principle with the aim of reducing the number of acquisition steps to the minimum necessary as a function of the number of contact points activated.

Working towards this solution entailed seeking to dispense with the compromise between spatial resolution and temporal resolution by scanning with different spatial resolutions in different detection areas of the sensor. This evolution of the spatial resolution must be such that the whole of the sensor is initially scanned at a low frequency to determine the contact areas. After this, only the detection areas containing detected contact areas are scanned again using an enhanced spatial resolution. This method may be carried out iteratively until scanned detection areas are obtained that are sufficiently narrow in relation to the detected contact areas. In order to obtain an overall scanning frequency identical to that for normal scanning of the whole of the sensor, scanning with enhanced spatial resolution is effected at a frequency higher than the overall scanning frequency.

To this end, the present invention proposes an acquisition and analysis method for a multicontact touch-sensitive sensor including a matrix of capture points and an acquisition and analysis electronic circuit for controlling acquisition and analysis of the matrix. The method comprises successively a step of acquisition of a sensor detection area in order to determine the state of each of the contact points of the detection area and a step of analysis of said detection area in order to deliver information as a function of the activation state of the contact points. According to the invention, the acquisition and analysis steps are repeated iteratively. The acquisition step is performed in a detection area containing the activated contact points determined during the preceding analysis step. The detection area is smaller than the detection area acquired during the preceding acquisition step. The iteration is effected until a predetermined spatial resolution is obtained.

Such a method reduces the quantity of measurements to be effected. In each new iteration, acquisition applies to only one of the detection areas previously acquired as a function of the detection of an activated contact point. This method makes it possible not to effect measurements in detection areas where there is no activated contact.

During the first iteration the acquisition step is preferably effected on the whole of the sensor. It is thus possible to obtain information on the state of the sensor as a whole before proceeding to the subsequent iterations that will refine the locations of the contact points.

During an iteration, the detection area to be processed is divided into smaller detection sub-areas and contact information is acquired independently for each detection sub-area. The next iteration is effected in each detection sub-area producing contact information. This avoids effecting iterations in detection areas with no activated contact point.

If no contact point is detected as being activated during an iteration the next iteration is advantageously effected on the whole of the sensor.

The detection area acquired during the acquisition and analysis steps of each iteration is advantageously of rectangular shape.

In one particular embodiment, in each iteration the dimensions on each axis of the area to be acquired are respectively divided by two numbers.

In each iteration the size of the area to be acquired is preferably the size of the area acquired during the preceding iteration divided by four. This makes possible a true dichotomous acquisition and analysis method. In each iteration the detection area previously acquired is divided into four detection sub-areas of equal size and the position of the contact area is identified therein. Thus during each iteration only the detection sub-area that included the contact area is scanned again.

In one embodiment, addressing the situation where a plurality of contact areas is detected, if a plurality of contact areas is distinctly detected during an iteration the acquisition and analysis steps of the next iteration are effected in parallel in each of the contact areas.

The invention also concerns an acquisition and analysis electronic circuit for multicontact touch-sensitive sensors comprising a matrix of contact points using such an acquisition and analysis method.

In a first embodiment of the invention the measurement of a detection area is effected by simultaneously energizing all columns of the detection area and measuring in common all rows of the detection area.

In a second embodiment of the invention a detection area is measured by energizing simultaneously all columns of the detection area and measuring separately all rows of the detection area.

In the case of multicontact touch-sensitive sensors comprising an active matrix of contact points comprising a transistor, a detection area is preferably measured by simultaneously energizing all columns and all rows of the detection area and measuring the common electrode of the sensor.

The invention finally concerns a multicontact touch-sensitive sensor comprising a matrix of capture points and such an acquisition and analysis electronic circuit for commanding acquisition and analysis of the matrix using such an acquisition and analysis method.

### BRIEF DESCRIPTION OF THE DRAWINGS

The invention will be better understood on reading the detailed description of one nonlimiting embodiment, accompanied by figures respectively showing:

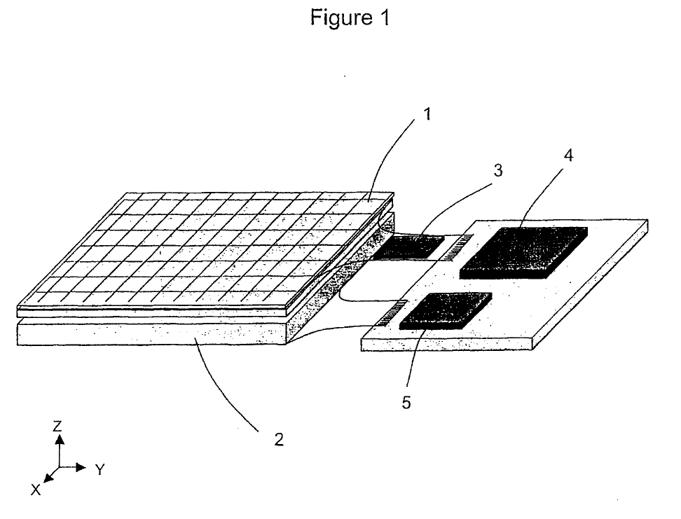

in FIG. 1, a view of a passive matrix multicontact touch-sensitive electronic device,

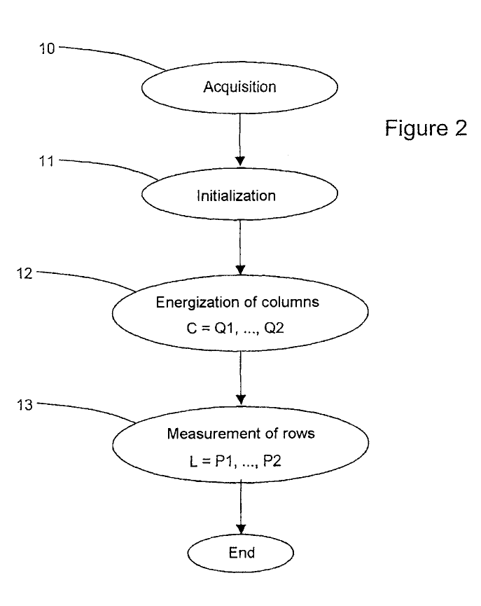

in FIG. 2, a diagram of a method of acquisition in an area of the sensor used by the electronic circuit,

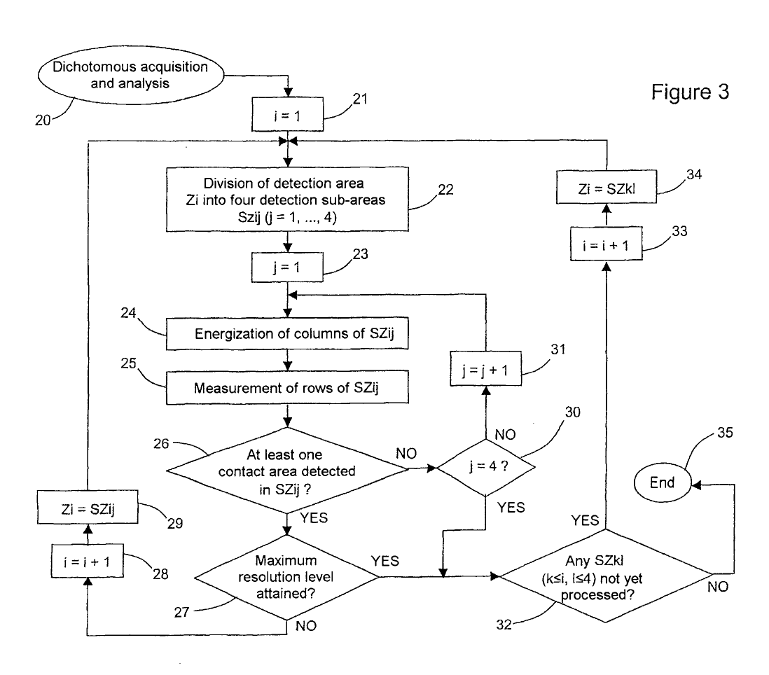

in FIG. 3, a diagram of an acquisition and analysis method of one embodiment of the present invention, and

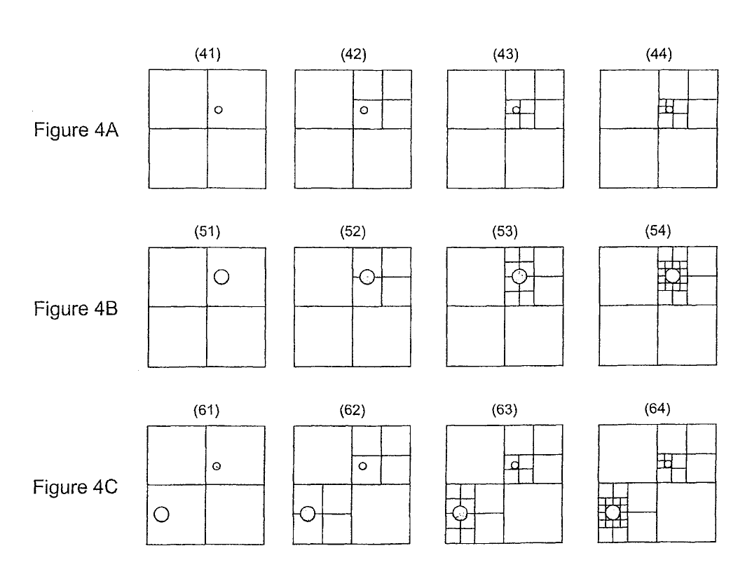

in FIGS. 4A to 4C, different situations in which the acquisition and analysis method of the present invention is used.

### DETAILED DESCRIPTION OF PARTICULAR EMBODIMENTS

An acquisition and analysis electronic circuit of the invention is intended to be integrated into a matrix type multicontact touch-sensitive sensor. This may be a passive matrix, i.e. one consisting of two layers of transparent conductive material arranged in a matrix and separated by an insulative layer, or an active matrix, where each node of the matrix consists of an active component such as a transistor or a diode. The axes of the passive or active matrix are called columns for the command part and rows for the measurement part. The projected intersection of a row and a column forms a node.

FIG. 1 represents a view of a touch-sensitive electronic device comprising:
a matrix touch-sensitive sensor 1,
a display screen 2,
a capture interface 3,
a main processor 4, and
a graphics processor 5.

The first fundamental component of this touch-sensitive device is the touch-sensitive sensor 1, necessary for acquisition—multicontact manipulation—via a capture interface 3. This capture interface 3 contains the acquisition and analysis circuit. The touch-sensitive sensor 1 is of the matrix type. It may be divided into a plurality of parts in order to accelerate capture, these parts being scanned simultaneously.

Data from the capture interface 3 are filtered and sent to the main processor 4. This executes the local program for associating the data from the pad with graphical objects that are displayed on the screen 2 in order to be manipulated. The main processor 4 also sends to the graphical interface 5 data to be displayed on the display screen 2. This graphical interface may furthermore be driven by a graphics processor.

The matrix sensor 1 is for example a sensor of the resistive or projected capacitive type. It consists of two transparent layers on which are arranged rows or columns corresponding to conductive wires. Thus these layers form a matrix array of conductive wires.

To tell if a contact has been activated, the electrical characteristics—voltage, capacitance or inductance—are measured at the terminals of each node of the matrix. Using a sampling frequency of the order of 100 Hz, the device acquires data from the whole of the sensor 1 by means of the sensor 1 and the control circuit integrated into the main processor 4.

In the case of a passive matrix touch-sensitive sensor, acquisition is effected in the following manner: the columns are energized and the response on each row of the sensor is detected. Contact areas are determined as a function of these responses, corresponding to the nodes the state of which has been modified relative to the rest state. One or more sets of adjacent nodes are determined the states of which have been modified. A set of such adjacent nodes defines a contact area. Position information referred to in the present patent as a cursor is calculated from this set of nodes. In the case of a plurality of sets of nodes separated by inactive areas, a plurality of independent cursors is determined during the same scanning phase.

This information is refreshed periodically during new scanning phases. The cursors are created, tracked and destroyed as a function of the information obtained during successive scans. For example, the cursor is calculated by a barycentric function of the contact area. The general principle is to create as many cursors as contact areas have been determined on the touch-sensitive sensor and to follow their evolution over time. When the user removes a finger from the sensor the associated cursor is destroyed. In this way it is possible to capture simultaneously the positions of and changes in respect of a plurality of fingers on the touch-sensitive sensor.

The main processor 4 executes the program for associating the data from the sensor with graphical objects that are displayed on the display screen 2 in order to be manipulated.

FIG. 2 represents a diagram of a method of acquisition used by the electronic circuit over an area [P1, P2, Q1, Q2] of the sensor.

The matrix sensor 1 includes N rows and M columns. The function of the method 10 is to determine the state of the detection area of the matrix sensor 1, namely if this area comprises at least one contact point. This detection area [P1, P2, Q1, Q2] of the sensor comprises P=P2−P1 rows and Q=Q2−Q1 columns. The contour of this detection area is defined by the integer parameters P1, P2, Q1, Q2. Thus the method 10 measures the detection area delimited by rows P1 to P2 and columns Q1 to Q2.

This method corresponds to measurement of the detection area [P1, P2, Q1, Q2] as one block. The electrical characteristic of this detection area that is measured is the voltage, for example. This method gives the state of the detection area [P1, P2, Q1, Q2] of the matrix sensor 1 at a given time.

The acquisition method 10 begins with a step 11 of initializing the data obtained during a preceding acquisition. Here the column axis constitutes the energization axis and the row axis constitutes the detection axis. The method then energizes 12 the columns Q1 to Q2 while all the rows P1 to P2 are measured 13 simultaneously.

A measurement is thus obtained for the whole of the block delimited by the columns Q1 and Q2 and the rows P1 and P2. Detecting a non-zero voltage means that there is at least one contact point in the detection area [P1, P2, Q1, Q2] and detecting a zero voltage means the absence of any contact in this detection area [P1, P2, Q1, Q2].

This acquisition process is used in the acquisition and analysis method of the invention described hereinafter to effect acquisition in a detection area to obtain contact information for the area as a whole and not for each of the nodes of the area.

FIG. 3 represents a diagram of an acquisition and analysis method used in one embodiment of the invention.

This method 20 consists of a series of iterative steps:
start of iteration in a detection area,
division of detection area into N detection sub-areas,
for each detection sub-area:
common command of columns relating to sub-area,
measurement of rows relating to sub-area,
determination of contact information for sub-area,
if contact detected, subsequent iteration in sub-area.

The first area considered by the method 20 is the area Z1 corresponding to the whole of the sensor. This area is divided during the step 22 into four sub-areas SZ11, SZ12, SZ13 and SZ14. There follow simultaneously energization 24 of the columns of the first sub-area SZ11 and measurement 25 of the rows of this sub-area SZ11. The energization step 24 and the measurement step 25 are preceded by a step (not shown) of initializing the detection sub-area concerned.

If no contact is detected in this sub-area SZ11, there follows energization 24 of the columns of sub-area SZ12 and measurement 25 on its rows, and so on until these operations have been effected for all four sub-areas SZ11, SZ12, SZ13 and SZ14.

If contact is present in the sub-area SZ11, it is first verified if the maximum spatial resolution level has been reached. If it has been reached, it is not possible to divide the sub-area SZ11 concerned into four new sub-areas. If not, the sub-area SZ11 becomes an area Z2 and there follows division 22 of this area into four sub-areas SZ21, SZ22, SZ23 and SZ24 followed by energization 24, measurement 26 and detection 26 of contact in these four sub-areas successively and iteratively, in exactly the same way as was done in the sub-area SZ11. The areas in which these different steps are executed are designated “Zi”, where i is an increment for distinguishing between these areas to be processed.

The method proceeds in this manner until the maximum resolution level is reached or all four sub-areas have been processed. There then follows verification 32 of the existence of other sub-areas that might not have been processed. If a sub-area “SZkl” (where k≦i and l≦4, being an increment for distinguishing between the successively processed areas) has not been processed (i.e. if there has been no energization of the columns, measurement of the rows and determination of the existence, if any, of contact in that sub-area), the same processing is applied again to this sub-area SZkl. To this end, the integer i is incremented by unity and the sub-area SZkl becomes an area Zi.

If there are no more sub-areas to be processed, the acquisition and analysis method is stopped 35. Thus this method determines detection areas in which a contact is present up to a predetermined spatial resolution level. This predetermination may be implemented manually by the user or be simply set by the number of nodes of the sensor. It is thus possible to obtain information with the maximum resolution level in only the activated contact areas. Sub-areas in which no contact has been detected are not processed by this method and thus do not have to be observed until the maximum spatial resolution level is reached, which significantly limits the quantity of information obtained during sensor acquisition and analysis.

This method executes iteratively:
acquisition steps corresponding to the energization step 24 and the measurement step 25 (preceded by a step, not shown in FIG. 3, of initializing the area to be acquired), and
analysis steps corresponding to the interrogation step 26 regarding the possible presence of contact in the detection area in which the acquisition is effected.

Once the acquisition and analysis method 20 has finished, the software is able to determine cursors corresponding to the activated contact areas and to apply specific processing to the virtual graphical objects on the touch-sensitive screen in order to refresh the touch-sensitive screen in real time.

FIGS. 4A and 4C show respective different situations in which the analysis and acquisition method of the present invention is used.

During each iteration each detection area is divided into four detection sub-areas. Thus four successive iterations produce a spatial resolution on each axis equal to 1/16.

In FIG. 4A a single contact area of the sensor is activated. During the first iteration 41, a detection area consisting of the whole of the sensor is divided into four detection sub-areas of equal size and the position of the contact area is identified in one of the detection sub-areas. During the second iteration 42, the detection area including the detected contact zone is divided into four detection sub-areas of equal size and the position of the contact area is identified in these new detection sub-areas. The subsequent iterations 43 and 44 repeat the same process until the required spatial resolution is obtained.

More generally, the number of detection areas measured depends on the number of contact areas activated and the maximum number of iterations.

Thus in the FIG. 4A example this dichotomous method obtains the position of the contact point with an accuracy of 1/16 on each axis in four iterations (16 measurements). In the case of standard scanning, equivalent accuracy would necessitate 256 measurements.

Referring to FIG. 4B, a contact area is activated in a plurality of detection areas. During the first iteration 51, the detection area consisting of the whole of the sensor is divided into four detection sub-areas of equal size and the position of the contact area is identified in only one of the detection sub-areas. During the second iteration 52, this new area is divided into four sub-areas of equal size and the contact area is detected in two new sub-areas. Then, in the iterations 53 and 54, each of these new detection areas having in part at least one contact area is divided into four new detection sub-areas and the position of the contact area therein are identified.

Referring to FIG. 4C, two distinct contact areas are detected in the first iteration 61. During the subsequent iterations 62, 63 and 64, each detection area identified as including at least in part a contact area is divided into four detection sub-areas of equal size and the positions of the contact areas therein are identified until the required resolution is obtained in the contact areas.

In these last two situations, illustrated by FIGS. 4B and 4C, this method obtains the position of the contact points with an accuracy of 1/16 on each axis in four iterations (respectively 32 and 44 measurements). In the case of standard scanning, equivalent accuracy would necessitate 256 measurements.

In another embodiment of the invention, the dichotomous method combines two dichotomies. A first step entails a horizontal dichotomy and a second step entails a vertical dichotomy. Each of these two steps corresponds to a separation of the area previously acquired into two new areas of equal size. The succession of these two dichotomies produces a dichotomous method identical to that described above and illustrated by FIGS. 3, 4A, 4B and 4C.

In another embodiment of the invention, the dichotomous method is implemented by dividing the area previously acquired not into four new areas but into any different number of new areas, for example nine, twelve or sixteen areas.

In a number of embodiments, the iterative method can be implemented as in the following examples:
an iteration over one sub-area is effected directly after the detection of an activated contact point therein, which necessitates a functional recursion and thus storing the locations and sizes of the areas encompassing said sub-area,
an iteration consisting in measuring all the sub-areas corresponding to all the detection areas comprising at least one activated contact point detected by the preceding iteration, which does not necessitate recursion but leads to storing a greater quantity of data.

The embodiments of the present invention described above are described by way of example and are in no way limiting on the invention. It is understood that the person skilled in the art is in a position to produce different variants of the invention without departing from the scope of the patent.

1-12. (canceled)

13. An acquisition and analysis method for a multicontact touch-sensitive sensor including a matrix of capture points and an acquisition and analysis electronic circuit for controlling acquisition and analysis of the matrix, the method comprising:
acquisition in a sensor detection area to determine a state of each of contact points of the detection area; and
analysis of the detection area to deliver information as a function of an activation state of the contact points,
wherein the acquisition and the analysis are repeated iteratively, the acquisition being performed in a detection area containing the activated contact points determined during a preceding analysis, the detection area being smaller than the detection area acquired during a preceding acquisition, and iteration being effected until a predetermined spatial resolution is obtained.

14. An acquisition and analysis method according to claim 13, wherein during a first iteration the acquisition is effected on the whole of the sensor.

15. An acquisition and analysis method according to claim 13, wherein if no activated contact point is detected during an iteration a next iteration is effected on the whole of the sensor.

16. An acquisition and analysis method according to claim 13, wherein the detection area acquired during the acquisition and the analysis of each iteration is of rectangular shape.

17. An acquisition and analysis method according to claim 13, wherein in each iteration dimensions on each axis of an area to be acquired are respectively divided by two numbers.

18. An acquisition and analysis method according to claim 17, wherein in each iteration a size of the area to be acquired is a size of the area acquired during the preceding iteration divided by four.

19. An acquisition and analysis method according to claim 13, wherein if a plurality of distinct contact areas is detected during an iteration the acquisition and the analysis of a next iteration are effected in parallel in each of these contact areas.

20. An acquisition and analysis electronic circuit for multicontact touch-sensitive sensors comprising a matrix of contact points using an acquisition and analysis method according to claim 13.

21. An acquisition and analysis electronic circuit according to claim 20, wherein the measurement of a detection area is effected by simultaneously energizing all columns of the detection area and measuring in common all rows of the detection area.

22. An acquisition and analysis electronic circuit according to claim 20, wherein a detection area is measured by energizing simultaneously all columns of the detection area and measuring separately all rows of the detection area.

23. An acquisition and analysis electronic circuit according to claim 20 for multicontact touch-sensitive sensors comprising an active matrix of contact points comprising a transistor, wherein a detection area is measured by simultaneously energizing all columns and all rows of the detection area and measuring the common electrode of the sensor.

24. A multicontact touch-sensitive sensor comprising a matrix of capture points and an acquisition and analysis electronic circuit according to claim 20 for commanding acquisition and analysis of the matrix.
